(19) United States
(12) Patent Application Publication
(10) Pub. No.: US 2018/0268956 A1
(43) Pub. Date: Sep. 20, 2018

(54) COMPOSITION FOR ELECTRIC WIRE COATING MATERIAL, INSULATED ELECTRIC WIRE, AND WIRE HARNESS

(71) Applicants: AutoNetworks Technologies, Ltd., Yokkaichi (JP); Sumitomo Wiring Systems, Ltd., Yokkaichi (JP); SUMITOMO ELECTRIC INDUSTRIES, LTD., Osaka (JP)

(72) Inventor: Tatsuya SHIMADA, Yokkaichi (JP)

(21) Appl. No.: 15/904,745

(22) Filed: Feb. 26, 2018

(30) Foreign Application Priority Data
Mar. 16, 2017 (JP) 2017-050961

(51) Int. Cl. H01B 3/44; C08L 83/04; C08K 5/5419; C08G 81/02; C08K 5/00; C08K 5/3415

(52) U.S. Cl. CPC H01B 3/44; C08L 83/04; C08K 5/5419; C08K 5/3415; C08K 5/0066; C08K 5/0025; C08G 81/024

(57) ABSTRACT

A composition for an electric wire coating material, the composition being a silane-crosslinkable polyolefin-based composition that has excellent flame retardancy and being able to reduce a moisture adsorption amount, and an insulated electric wire and a wire harness that use this composition. The composition containing a silane-crosslinked polyolefin as a main component, contains a silane-grafted polyolefin obtained by grafting a silane coupling agent onto a polyolefin having a density of 0.860 to 0.920 g/cm³, an unmodified polyolefin having a density of 0.860 to 0.955 g/cm³, a copolymerized polyolefin of a polymerizable compound having one or two functional groups selected from a carboxy group and an epoxy group and at least one polymerizable monomer that can be copolymerized with the polymerizable compound having the functional groups, an inorganic flame retardant or inorganic-flame retardant auxiliary agent, and an crosslinking catalyst.

### CROSS REFERENCE TO RELATED APPLICATIONS

This application claims the priority of Japanese patent application JP2017-050961 filed on Mar. 16, 2017, the entire contents of which are incorporated herein.

### TECHNICAL FIELD

The present invention relates to a composition for an electric wire coating material, an insulated electric wire, and a wire harness, and more specifically relates to a composition for an electric wire coating material that is suitable as a coating material for an electric wire routed in a vehicle such an automobile, and an insulated electric wire and a wire harness that use this composition for an electric wire coating material.

### BACKGROUND ART

In recent years, due to the spread of hybrid cars and the like, electric wires, connectors, and the like, which are automobile components, have been required to be highly voltage resistant, highly heat resistant, and the like. Conventionally, a crosslinked polyvinyl chloride resin or a crosslinked polyolefin resin has been used as a coating material of an insulated electric wire used in a place having a high temperature, such as a wire harness of an automobile. Electron beam crosslinking has mainly been used as the method for crosslinking these resins (for example, Patent Document 1).

However, there has been a problem in that electron beam crosslinking requires an expensive electron beam crosslinking apparatus and the like, and equipment cost is high, and thus manufacturing cost increases. In view of this, silane crosslinking, with which crosslinking is possible with inexpensive equipment, has been receiving attention. A silane-crosslinkable polyolefin composition is known which is used in a coating material for an electric wire, a cable, and the like (for example, Patent Document 2).

JP 2000-294039A and JP 2000-212291A are examples of related art.

### SUMMARY

Meanwhile, if an insulated electric wire is used as an electric wire for an automobile, in general, flame retardancy is required. In order to meet flame retardancy, it is necessary to add a flame retardant, and an inorganic flame retardant typified by metal hydroxides needs to be added in a large amount in order to satisfy the flame retardancy performance.

However, an inorganic flame retardant has poor affinity with resin components, and if a large amount of inorganic flame retardant is added, the composition tends to adsorb cooling water or moisture in the air. Crosslinking of the silane crosslinking material is promoted by moisture in the air, and thus is called “water crosslinking”. Thus, there is a concern that if pellets contain moisture, an unintended crosslinking reaction will proceed during storage or during foaming and molding, and hardened material will be produced in parts thereof.

The present application aims to provide a composition for an electric wire coating material, the composition being a silane-crosslinkable polyolefin-based composition that has excellent flame retardancy, and being able to reduce the moisture adsorption amount, and to provide an insulated electric wire and a wire harness that use this composition.

A composition for an electric wire coating material according to the present application, comprising:
(A) a silane-grafted polyolefin obtained by grafting a silane coupling agent onto a polyolefin having a density of 0.860 to 0.920 g/cm3;
(B) an unmodified polyolefin having a density of 0.860 to 0.955 g/cm3;
(C) a copolymerized polyolefin of a polymerizable compound having one or two functional groups selected from a carboxy group and an epoxy group and at least one polymerizable monomer that can be copolymerized with the polymerizable compound having the functional groups;
(D) an inorganic flame retardant or an inorganic flame retardant auxiliary agent; and
(E) a crosslinking catalyst.

The composition for an electric wire coating material according to the present application, preferably further comprising:
(F) a combination of zinc oxide and an imidazole-based compound, or zinc sulfide;
(G) one or more selected from an antioxidant, a metal deactivator, and a lubricant; and
(H) a silicone oil.

A polymerizable monomer of the (C) copolymerized polyolefin preferably has one or more functional groups selected from an acrylic group, a methacrylic group, an ester group, a hydroxy group, and an amino group.

The (C) copolymerized polyolefin is preferably a multi-component copolymerized polyolefin constituted by

a polymerizable compound having one or two functional groups selected from a carboxy group and an epoxy group,

a polymerizable monomer having one or more functional groups selected from an acrylic group, a methacrylic group, an ester group, a hydroxy group, and an amino group, and

an olefin monomer having no functional groups.

The (C) copolymerized polyolefin preferably contains a polymerizable compound having a carboxy group, and

the polymerizable compound having a carboxy group is preferably one or more selected from maleic acid, maleic anhydride, and derivatives thereof.

Preferably, the blending amounts of the (A), (B), and (C) components are such that the composition contains

the (A) silane-grafted polyolefin in an amount of 30 to 90 parts by mass, and

the (B) unmodified polyolefin and the (C) copolymerized polyolefin in an amount of 10 to 70 parts by mass in total.

Preferably, the blending amounts of the (D) to (H) components are such that the composition contains

with respect to 100 parts by mass in total of the (A), (B), and (C) components,

the (D) inorganic flame retardant in an amount of 50 to 200 parts by mass,

a crosslinking catalyst batch in an amount of 2 to 20 parts by mass, the crosslinking catalyst batch containing the (E) crosslinking catalyst in an amount of 0.5 to 5 parts by mass with respect to 100 parts by mass of a binder resin,

zinc oxide and an imidazole-based compound each in an amount of 1 to 15 parts by mass if the (F) component is the combination of zinc oxide and the imidazole-based compound, or zinc sulfide in an amount of 1 to 15 parts by mass if the (F) component is zinc sulfide,

the (G) antioxidant, metal deactivator, and lubricant each in an amount of 1 to 10 parts by mass, and

the (H) silicone oil in an amount of 0.5 to 5 parts by mass.

Preferably, polyolefins that constitute the (A) silane-grafted polyolefin and the (B) unmodified polyolefin are each one or more selected from very-low-density polyethylene, linear low-density polyethylene, and low-density polyethylene.

The (C) copolymerized polyolefin preferably contains one or two selected from a carboxy group and an epoxy group in an amount of 0.5 to 5 mass % in total.

An insulated electric wire according to the present application includes an electric wire coating material obtained by crosslinking the above-described composition for an electric wire coating material.

A wire harness according to the present application includes the above-described insulated electric wire.

The composition for an electric wire coating material according to the present invention contains (C) a copolymerized polyolefin, and thus has high affinity with (D) an inorganic flame retardant or an inorganic flame retardant auxiliary agent, other inorganic components, and resin components, and the water adsorption amount is reduced. The composition for an electric wire coating material according to the present invention is a silane-crosslinking material, but the moisture adsorption amount of the pellets is low, and thus it is possible to suppress formation of partially hardened material in parts thereof during storage or molding, for example.

Furthermore, the composition for an electric wire coating material has excellent affinity with inorganic components and resin components, and thus loss of inorganic components can be suppressed, and abrasion resistance can be increased.

The (C) copolymerized polyolefin according to the present application contains, as a copolymer component, a polymerizable compound having one or two functional groups selected from a carboxy group and an epoxy group, and thus, these functional groups can be introduced into molecules in a large amount, and as described above, the (C) copolymerized polyolefin has an excellent effect in increasing the affinity with inorganic components and resin components. For example, if a compound having a carboxy group and an epoxy group is graft-polymerized onto a polyolefin, it is difficult to introduce a large amount of functional groups, and a polyolefin has a poorer effect in increasing the affinity with inorganic components and resin components, compared to the (C) copolymerized polyolefin. The composition for an electric wire coating material according to the present invention contains the (C) copolymerized polyolefin that has an excellent effect in increasing the affinity with inorganic components and resin components, and thus it is possible to add the (D) inorganic flame retardant or inorganic flame retardant auxiliary agent, and other inorganic components in a sufficient amount to provide flame retardancy and the like thereto, while suppressing water adsorption.

### EMBODIMENTS OF THE INVENTION

Next, an embodiment of the present application will be described in detail.

A composition for an electric wire coating material according to the present application contains (A) a silane-grafted polyolefin, (B) an unmodified polyolefin, (C) a copolymerized polyolefin, (D) an inorganic flame retardant or an inorganic flame retardant auxiliary agent, and (E) a crosslinking catalyst. Furthermore, the composition for an electric wire coating material preferably contains (F) an age resister, (G) an antioxidant, a metal deactivator, and a lubricant, and (H) a silicone oil. Details of the components will be described below.

The (A) silane-grafted polyolefin is obtained by introducing a silane-grafted chain into a polyolefin serving as a main chain by graft-polymerizing a silane coupling agent onto the polyolefin.

A polyolefin that constitutes the silane-grafted polyolefin preferably has a density of 0.860 to 0.920 g/cm3 and more preferably has a density of 0.865 to 0.900 g/cm3. Although a silane coupling agent is easily grafted onto a polyolefin having a lower density, if the density is less than 0.860 g/cm3, the heat resistance, chemical resistance, and abrasion resistance of the electric wire tend to decrease, and blocking of pellets will easily occur. On the other hand, if the density of the polyolefin exceeds 0.920 g/cm3, there is a risk that the graft rate and the flexibility will decrease due to an increase in crystal components. Note that the density of the polyolefin can be measured in conformity with D790 of ASTM standards.

Examples of the polyolefin used in the silane-grafted polyolefin include homopolymers of ethylene, propylene, and other olefins, copolymers of two or more thereof, ethylene-vinyl acetate copolymers, ethylene-acrylic acid ester copolymers, and ethylene-methacrylic acid ester copolymers, propylene-vinyl acetate copolymers, propylene-acrylic acid ester copolymers, and propylene-methacrylic acid ester copolymers. These may be used alone or in combination. It is preferable to use one or more selected from at least polyethylene, polypropylene, ethylene-butene copolymers, ethylene-octene copolymers, ethylene-vinyl acetate copolymers, ethylene-acrylic acid ester copolymers, and ethylene-methacrylic acid ester copolymers.

Low-density polyethylene (LDPE), linear low-density polyethylene (LLDPE), very-low-density polyethylene (VLDPE), or metallocene low-density polyethylene is preferably used as the polyethylene. These may be used alone or in combination. If these low-density polyethylenes are used, the electric wire will have good flexibility and excellent extrudability, and productivity will increase.

Also, a polyolefin elastomer obtained by using olefin as the base may be used as the above-described polyolefin. The polyolefin elastomer can provide a coating material with flexibility. Examples of the polyolefin elastomer include polyolefin-based thermoplastic elastomers (TPO) such as polyethylene-based elastomers (PE elastomers) and propylene-based elastomers (PP elastomers), ethylene-propylene rubbers (EPM, EPR), and ethylene propylene-diene copolymers (EPDM, EPT).

There is no particular limitation thereto, and examples of the silane coupling agent used in the silane-grafted polyolefin include vinyl alkoxysilanes such as vinyltrimethoxysilane, vinyltriethoxysilane, and vinyltributoxysilane, n-hexyltrimethoxysilane, vinylacetoxysilane, γ-methacryloxypropyltrimethoxysilane, and γ-methacryloxypropylmethyldimethoxysilane. These may be used alone or in combination.

From the viewpoint of preventing excess crosslinks, an upper limit of the graft amount of the silane coupling agent is preferably 10 mass % or less, more preferably 5 mass % or less, and even more preferably 3 mass % or less. On the other hand, from the viewpoint of sufficiently crosslinking the coating layer, a lower limit of the graft amount is preferably 0.1 mass % or more, more preferably 1.0 mass % or more, and even more preferably 1.5 mass % or more. Note that the graft amount expresses the mass of the grafted silane coupling agent in a percentage with respect to the mass of the polyolefin before silane grafting.

A silane-grafted polyolefin can be prepared by adding a free radical generating agent to a polyolefin and a silane coupling agent, and mixing the mixture with a twin-screw extrusion kneader or single screw extrusion kneader, for example. In addition, when the polyolefin is polymerized, a method of adding a silane coupling agent may be used.

At this time, the blending amount of the silane coupling agent is preferably in a range of 0.5 to 5 parts by mass, and more preferably in a range of 3 to 5 parts by mass, with respect to 100 parts by mass of the polyolefin. When the blending amount of the silane coupling agent is 0.5 parts by mass or more, the polyolefin is grafted sufficiently. On the other hand, if the blending amount of the silane coupling agent is 5 parts by mass or less, a crosslinking reaction does not proceed excessively during mixing, enabling the formation of gel-like substances to be suppressed, and productivity and workability are excellent.

Examples of the free radical generating agent include organic peroxides such as dicumyl peroxide (DCP), benzoyl peroxide, dichlorobenzoyl peroxide, di-tert-butyl peroxide, butyl peracetate, tert-butyl perbenzoate, and 2,5-dimethyl-2,5-di(tert-butyl peroxide) hexane. Dicumyl peroxide (DCP) is preferable as the free radical generating agent.

If dicumyl peroxide (DCP) is used as the free radical generating agent, a mixing temperature at which the silane coupling agent is graft-polymerized onto the polyolefin is preferably set to 120° C. or more.

The blending amount of the free radical generating agent is preferably in a range of 0.025 to 0.1 parts by mass with respect to 100 parts by mass of the polyolefin that is subjected to silane-grafting. If the blending amount of the free radical generating agent is 0.025 parts by mass or more, a grafting reaction proceeds sufficiently. On the other hand, if the blending amount of the free radical generating agent exceeds 0.1 parts by mass, the ratio of cleaving polyolefin molecules increases, and unintended peroxide crosslinking readily proceeds, and it is difficult to obtain a target silane-grafted polyolefin.

The free radical generating agent may be added after being diluted with an inert substance such as talc or calcium carbonate, or may be added after being diluted with ethylene-propylene rubber, ethylene-propylene-diene rubber, polyolefin-α olefin copolymers, or the like and formed into pellets.

The (B) unmodified polyolefin is a polyolefin that is not subjected to graft modification using a silane coupling agent. The unmodified polyolefin having a density of 0.860 to 0.955 g/cm3 is used. A more preferable density of the unmodified polyolefin is in a range of 0.89 to 0.92 g/cm3. If the density of the unmodified polyolefin is less than 0.860 g/cm3, the heat resistance, chemical resistance, and abrasion resistance of the electric wire tend to decrease. Also, if the density of the unmodified polyolefin exceeds 0.955 g/cm3, the flexibility decreases.

Examples of the unmodified polyolefin include homopolymers of ethylene, propylene, and other olefins, copolymers of two or more thereof, ethylene-vinyl acetate copolymers, ethylene-acrylic acid ester copolymers, and ethylene-methacrylic acid ester copolymers, propylene-vinyl acetate copolymers, propylene-acrylic acid ester copolymers, and propylene-methacrylic acid ester copolymers. However, copolymers of an acrylic acid ester and a methacrylic acid ester that have a carboxy group or an ester group, such as glycidyl acrylate are added as the (C) copolymerized polyolefin, and thus such copolymers are not included in the (B) unmodified polyolefin. These may be used alone or in combination. It is preferable to use one or more selected from at least polyethylene, polypropylene, ethylene-butene copolymers, ethylene-octene copolymers, ethylene-vinyl acetate copolymers, ethylene-acrylic acid ester copolymers, and ethylene-methacrylic acid ester copolymers.

Low-density polyethylene (LDPE), linear low-density polyethylene (LLDPE), very-low-density polyethylene (VLDPE), or metallocene low-density polyethylene is preferably used as the polyethylene. These may be used alone or in combination. If these low-density polyethylenes are used, the electric wire will have good flexibility and excellent extrudability, and productivity will increase.

Also, a polyolefin elastomer obtained by using olefin as the base may be used as the above-described polyolefin. The polyolefin elastomer can provide a coating material with flexibility. Examples of the polyolefin elastomer include polyolefin-based thermoplastic elastomers (TPO) such as polyethylene-based elastomers (PE elastomers) and propylene-based elastomers (PP elastomers), ethylene-propylene rubbers (EPM, EPR), and ethylene propylene-diene copolymers (EPDM, EPT).

A polyolefin that is the same as or different from that used in the main chain of the (A) silane-grafted polyolefin may be used as the (B) unmodified polyolefin. If the same type of polyolefin is used, the compatibility therebetween is excellent.

The (C) copolymerized polyolefin is a copolymerized polyolefin of a polymerizable compound having one or two functional groups selected from a carboxy group and an epoxy group and at least one polymerizable monomer that can be copolymerized with the polymerizable compound having the functional groups. The (C) copolymerized polyolefin is not silane-grafted.

The (C) copolymerized polyolefin has one or two functional groups selected from a carboxy group and an epoxy group, and thus has a strong interaction with the (D) inorganic flame retardant or inorganic flame retardant auxiliary agent, and other inorganic components, and the (C) copolymerized polyolefin has a polyolefin chain, and thus has high affinity with resin components such as the (A) silane-grafted polyolefin and the (B) unmodified polyolefin. Therefore, the (C) copolymerized polyolefin can be used as a compatibilizer for resin components and inorganic components, and can suppress water adsorption.

There is no particular limitation on the polymerizable compound having a carboxy group as long as the polymerizable compound has a carboxy group and a polymerizable group such as a carbon-carbon double bond in a molecule. Examples thereof include acrylic acid, methacrylic acid, crotonic acid, α-chloroacrylic acid, itaconic acid, butene tricarboxylic acid, maleic acid, fumaric acid, and derivatives containing these in a part of a molecular structure. If these acids form acid anhydride, such acid anhydride may be used. From the viewpoint of easy interaction with inorganic components, maleic acid, maleic anhydride, or derivatives thereof are preferable.

There is no particular limitation on the polymerizable compound having an epoxy group as long as the compound has an epoxy group and a polymerizable group such as a carbon-carbon double bond in a molecule. Examples thereof include acid glycidyl esters, which are condensed esters of glycidyl alcohol and acids such as acrylic acid, methacrylic acid, crotonic acid, α-chloroacrylic acid, itaconic acid, butene tricarboxylic acid, maleic acid, and fumaric acid, and, glycidyl ethers such as vinyl glycidyl ether, allyl glycidyl ether, glycidyloxyethyl vinyl ether, and styrene-p-glycidyl ether, p-glycidyl styrene, and derivatives containing these in a part of a molecular structure.

There is no particular limitation on the polymerizable monomer that can be copolymerized with the polymerizable compound having a carboxy group or an epoxy group as long as the compound has a polymerizable group such as a carbon-carbon double bond in a molecule. For example, an olefin monomer having no functional groups, such as ethylene or propylene, may be used, or a polymerizable monomer having a functional group other than a carboxy group and an epoxy group may be used. These may be used alone or in combination. A multi-component copolymer obtained by using one or more types of simple olefin monomer and one or more types of polymerizable monomer having a functional group is preferable. A polymerizable monomer having a functional group is included, the adhesiveness to inorganic components increases, and an olefin monomer having no functional groups is included as the base monomer, relatively good oil resistance is exhibited, and when mixing treatment is performed for a long period of time, resin burning caused by applying unintended heat to a portion of the resin can be easily suppressed.

There is no particular limitation on the functional groups other than the above-described carboxy group and epoxy group as long as they do not inhibit an object of the present application. It is preferable that the polymerizable monomer preferably has one or more functional groups selected from an acrylic group, a methacrylic group, an ester group a hydroxy group, and an amino group. However, compounds having both other functional groups and a carboxy group or an epoxy group, such as glycidyl esters of acrylic acid or methacrylic acid, are handled as compounds having a carboxy group or an epoxy group. If a compound having these functional groups, the compound has an excellent effect in increasing the affinity with inorganic components and resin components due to the synergistic effect of a carboxy group and an epoxy group.

There is no particular limitation on the polymerizable monomer having one or more functional groups selected from an acrylic group, a methacrylic group, an ester group, a hydroxy group, and an amino group, and examples thereof include alkyl esters of acids (e.g., acrylic acid or methacrylic acid), such as methyl acrylate, ethyl acrylate, methyl methacrylate, and ethyl methacrylate, and condensed esters of acids (e.g., acrylic acid or methacrylic acid) and a compound having an amino group, such as 2-aminoethyl acrylate, 3-(diethylamino) propyl acrylate, 2-aminoethyl methacrylate, and 3-(diethylamino) propyl methacrylate. Among these, from the viewpoint of an excellent effect in increasing the affinity with inorganic components and resin components due to a synergistic effect of the carboxy group and the epoxy group, inexpensive, and easy obtainment, methyl acrylate, ethyl acrylate, methyl methacrylate, and ethyl methacrylate are preferable.

The (C) copolymerized polyolefin is different from a graft-modified polyolefin obtained by graft-polymerizing a compound having one or two functional groups selected from a carboxy group and an epoxy group. A graft polymerization reaction proceeds due to generation of radicals in polyolefin chains, and thus the graft polymerization reaction proceeds competitively with the crosslinking reaction of polyolefins. In general, a compound having a carboxy group, an epoxy group, or the like has a slower reaction speed than a silane coupling agent, and the crosslinking reaction of polyolefins, which is a competitive reaction, readily proceeds. Thus, if a functional group is introduced into a polyolefin through graft polymerization, in general, the polyolefin is modified such that a modification ratio is about 0.5 mass %. When attempts are made to introduce a functional group at a modification ratio of 0.5 mass % or more, it is necessary to generate a large number of radicals in the polyolefin, the crosslinking reaction of polyolefin chains proceeds, and the grafting reaction is unlikely to proceed. Note that the modification ratio expresses the mass of grafted functional groups in a percentage with respect to the mass of polyolefin before graft polymerization.

If attempts are made to increase the affinity with inorganic components using the modified polyolefin obtained through graft polymerization, in order to achieve a sufficient affinity, it is necessary to blend a large amount of the modified polyolefin. If the blending amount of the modified polyolefin increases, the modified polyolefin tends to adhere to the inner portion of a kneader and there is a concern that resin burning will be produced.

On the other hand, if one or more functional groups selected from a carboxy group and an epoxy group are introduced through copolymerization, the functional groups are introduced without deletion of the polyolefin chain, and thus a larger number of the functional groups can be introduced compared to a case where the polyolefin is graft polymerized. It is preferable that the above-described functional group is introduced into the (C) copolymerized polyolefin in a range of 0.5 to 5 mass %. If the modification ratio is 0.5 mass % or more, the copolymerized polyolefin has excellent affinity with inorganic components. If the modification ratio is 5 mass % or less, the copolymerized polyolefin is unlikely to adhere to the inner portion of the kneader, preventing unintended heat from being applied to the resin. An introduction amount of the functional group can be adjusted in accordance with the blending amount of monomer units during copolymerization.

The (C) copolymerized polyolefin according to the present application has an excellent effect in increasing the affinity with inorganic components and resin components because a large number of carboxy groups and/or epoxy groups can be introduced. In general, in a silane crosslinked resin, the higher the silane-grafted amount is, the greater the influence of moisture, and if a silane-grafted polyolefin obtained by silane modifying a low-density polyolefin is used as the component (A) according to the present invention, the ratio of silane-grafted chains increases, and moisture adsorption of inorganic components will be problematic. If the (C) copolymerized polyolefin is used in such a composition, the composition has excellent affinity with inorganic components and resin components, and a significant effect in reducing the moisture amount.

The blending amount of the (C) copolymerized polyolefin is preferably 3 to 15 parts by mass with respect to 100 parts by mass in total of the resin components (A) to (C). The blending amount thereof is more preferably 4 to 10 parts by mass. If the blending amount thereof is 3 parts by mass or more, the composition has excellent affinity with resin components and inorganic components, and if the blending amount thereof is 15 parts by mass or less, the resin is unlikely to adhere to the inner portion of the kneader, and resin burning can be prevented.

It is preferable that the blending amount of the (A) silane-grafted polyolefin is 30 to 90 parts by mass, and the total blending amount of the (B) unmodified polyolefin and the (C) copolymerized polyolefin is 10 to 70 parts by mass where the total amount of the above-described resin components (A) to (C) is 100 parts by mass. If the blending amounts are within the above-described ranges, the composition has excellent compatibility between inorganic components and each resin component, and resin components, and productivity and the dispersiveness of inorganic components increase.

Examples of the (D) inorganic flame retardant or inorganic flame retardant auxiliary agent include metal hydroxides and antimony trioxide. The metal hydroxides are flame retardants that independently provide flame retardancy, and antimony trioxide is an inorganic flame retardant auxiliary agent that increases the flame retardancy by being used in combination with a bromine-based flame retardant. From the viewpoint of the cost and excellent heat deformation resistance, for example, it is preferable to use metal hydroxides as these flame retardant components. Also, compared to series that are used in combination of a bromine-based flame retardant and an inorganic flame retardant auxiliary agent, metal hydroxides need to be added in a large amount in order to obtain sufficient flame retardancy. Thus, if metal hydroxides are used, the compatibilizing effect of the (C) copolymerized polyolefin is more significantly exhibited.

Examples of the metal hydroxides include magnesium hydroxide, aluminum hydroxide, and zirconium hydroxide. From the viewpoint of the cost and excellent heat deformation resistance, magnesium hydroxide is preferable among the above-described metal hydroxides.

An average particle size of a metal hydroxide is preferably 0.1 to 10 μm and more preferably 0.5 to 5 μm. Also, if the average particle size of a metal hydroxide is 0.1 μm or more, aggregation is unlikely to occur, and if the average particle size thereof is 10 μm or less, such a metal hydroxide has excellent dispersiveness. Also, in order to increase the dispersiveness, for example, metal hydroxides may be treated using a surface treatment agent such as a silane coupling agent, a higher fatty acid, or a polyolefin wax. In the present invention, the (C) copolymerized polyolefin is included, and thus, it is possible to increase the dispersiveness of a metal hydroxide without performing surface treatment.

Either a synthetic magnesium hydroxide that is chemically synthesized or a natural magnesium hydroxide obtained by crushing naturally occurring minerals may be used as magnesium hydroxide.

An inorganic flame retardant is preferably added in a range of 50 to 200 parts by mass with respect to 100 parts by mass in total of the resin components (A) to (C). If 50 parts by mass or more are added, excellent flame retardancy is achieved. In the present application, the composition contains the (C) copolymerized polyolefin, and thus the composition has excellent affinity with an inorganic flame retardant and resin components, and if a relatively large amount of the inorganic flame retardant is added, an increase in the moisture adsorption amount and a decrease in the abrasion resistance caused by loss of the inorganic flame retardant are unlikely to occur. However, from the viewpoint of excellent flexibility, the upper limit is preferably 200 parts by mass.

Antimony trioxide, which is an inorganic flame retardant auxiliary agent, can increase the flame retardancy by being added together with a bromine-based flame retardant. Antimony trioxide with a purity of 99% or more is preferably used. Antimony trioxide can be used by crushing antimony trioxide produced as minerals into microparticles. At this time, the average particle diameter is preferably 3 μm or less, and more preferably 1 μm or less. If the average particle diameter is 3 μm or less, such antimony trioxide particles have excellent strength of an interface with a resin. Also, in order to increase the dispersiveness, for example, antimony trioxide may be treated using a surface treatment agent such as a silane coupling agent, a higher fatty acid, or a polyolefin wax. In the present application, the composition contains the (C) copolymerized polyolefin, and thus, it is possible to increase the dispersiveness of antimony trioxide without performing surface treatment.

Examples of a bromine-based flame retardant that is added together with antimony trioxide, which is an inorganic flame retardant auxiliary agent, include bromine-based flame retardants having a phthalimide structure, such as ethylene bis(tetrabromophthalimide) and ethylene bis(tribromophthalimide), ethylene bispentabromophenyl, tetrabromobisphenol A (TBBA), hexabromocyclododecane (HBCD), TBBA-carbonate•oligomer, TBBA-epoxy•oligomer, brominated polystyrene, TBBA-bis(dibromopropyl ether), poly(dibromopropyl ether), and hexabromobenzene (HBB). These may be used alone or in combination. From the viewpoint of a high melting point and excellent heat resistance, it is preferably to use one or more selected from at least phthalimide-based flame retardants and ethylene bispentabromophenyl.

If a bromine-based flame retardant and an inorganic flame retardant auxiliary agent are used in combination as flame retardant components, the bromine-based flame retardant and the inorganic flame retardant auxiliary agent preferably have an equivalence ratio in a range of bromine-based flame retardant:inorganic flame retardant auxiliary agent=3:1 to 2:1.

The bromine-based flame retardant and the inorganic flame retardant auxiliary agent are preferably blended in a range of 10 to 70 parts by mass in the total amount of the bromine-based flame retardant and the inorganic flame retardant auxiliary agent, and are more preferably blended in a range of 20 to 60 parts by mass, with respect to 100 parts by mass in total of the resin components (A) to (C). If 10 parts by mass or more of the flame retardant components are blended, the composition has excellent flame retardancy. In the present application, the composition contains the (C) copolymerized polyolefin, and thus, the composition has excellent affinity with the inorganic flame retardant auxiliary agent and the resin components, and if a relatively large amount of the inorganic flame retardant auxiliary agent is added, an increase in the moisture adsorption amount and a decrease in the abrasion resistance caused by loss of the inorganic flame retardant auxiliary agent are unlikely to occur. However, from the viewpoint of excellent flexibility, the upper limit is preferably 70 parts by mass.

The (E) crosslinking catalyst is a silanol condensation catalyst for silane-crosslinking the (A) silane-grafted polyolefin. Examples of the crosslinking catalyst include carboxylates of metals such as tin, zinc, iron, lead, and cobalt, titanic acid esters, organic bases, inorganic acids, and organic acids. Specific examples thereof include dibutyltin dilaurate, dibutyltin dimaleate, dibutyltin mercaptide (dibutyltin bisoctylthioglycol ester, dibutyltin β-mercaptopropionate polymer, etc.), dibutyltin diacetate, dioctyltin dilaurate, stannous acetate, stannous caprylate, lead naphthenate, cobalt naphthenate, barium stearate, calcium stearate, tetrabutyl titanate, tetranonyl titanate, dibutylamine, hexylamine, pyridine, sulfuric acid, hydrochloric acid, toluene sulfonic acid, acetic acid, stearic acid, and maleic acid. Dibutyltin dilaurate, dibutyltin dimaleate, and dibutyltin mercaptide are preferable as the crosslinking catalyst.

When the crosslinking catalyst is mixed with the (A) silane-grafted polyolefin, a crosslinking reaction proceeds, and thus the crosslinking catalyst is preferably mixed immediately before an electric wire is coated. At this time, in order to increase the dispersiveness of the crosslinking catalyst, the crosslinking catalyst is preferably used as a crosslinking catalyst batch obtained by mixing the crosslinking catalyst and a binder resin in advance. Use of the above-described crosslinking catalyst as the crosslinking catalyst batch can suppress excessive reactions with other components such as a flame retardant. Also, the addition amount of the catalyst can be controlled easily.

A polyolefin that is used in the above-described (A) to (C) can be used as a binder resin used in the crosslinking catalyst batch. In particular, low-density polyethylene (LDPE), linear low-density polyethylene (LLDPE), very-low-density polyethylene (VLDPE), and metallocene low-density polyethylene are preferable. If these low-density polyethylenes are used, the electric wire will have good flexibility and excellent extrudability, and productivity will increase. Also, from the viewpoint of the compatibility, it is preferable to select a resin that is in the same series as that selected for (A) to (C).

The crosslinking catalyst batch preferably contains a crosslinking catalyst in an amount of 0.5 to 5 parts by mass and more preferably contains the crosslinking catalyst in an amount of 1 to 5 parts by mass, with respect to 100 parts by mass of the binder resin. If the crosslinking catalyst batch contains the crosslinking catalyst in an amount of 0.5 parts by mass or more, the crosslinking reaction readily proceeds, and if it contains the crosslinking catalyst in an amount of 5 parts by mass or less, the catalyst has excellent dispersiveness.

The crosslinking catalyst batch is desirably added in a range of 2 to 20 parts by mass, and more preferably added in a range of 5 to 15 parts by mass, with respect to 100 parts by mass in total of the resin components (A) to (C). In the case of containing 2 parts by mass or more, a crosslinking reaction readily proceeds, and in the case of containing 20 parts by mass or less, it is possible to suppress an excessive increase in the non-crosslinking components in the composition and to prevent a decrease in the flame retardancy and heat resistance.

The (F) combination of zinc oxide and imidazole-based compound, or zinc sulfide is used as additive agents for improving heat resistance and long-term heat resistance. Either the addition of only zinc sulfide or the combination of zinc oxide and the imidazole-based compound can achieve a similar effect.

The above-described zinc oxide can be obtained using a method of oxidizing, with air, zinc vapor generated by adding a reducing agent such as coke to a zinc ore and firing the mixture, or a method in which zinc sulfate or zinc chloride is used as the salt amount. There is no particular limitation on the method of manufacturing zinc oxide, and zinc oxide may be manufactured using any method. Also, zinc sulfide manufactured using a known method can be used. Average particle sizes of zinc oxide and zinc sulfide are preferably 3 μm or less, and more preferably 1 μm or less. If the average particle sizes of zinc oxide and zinc sulfide decrease, the strength of the interface with the resin increases and the dispersiveness also increases.

Mercaptobenzimidazoles are preferable as the above-described imidazole-based compound. Examples of the mercaptobenzimidazoles include 2-mercaptobenzimidazole, 2-mercaptomethylbenzimidazole, 4-mercaptomethylbenzimidazole, 5-mercaptomethylbenzimidazole, and zinc salts thereof. 2-mercaptobenzimidazole and zinc salts thereof are particularly preferable because they are stable at high temperature due to a high melting point and less sublimation during mixing.

It is preferable that the addition amount of zinc sulfide is 1 to 15 parts by mass, or the addition amount of zinc oxide and the addition amount of the imidazole-based compound are respectively 1 to 15 parts by mass, with respect to 100 parts by mass in total of the resin components (A) to (C). If the addition amount thereof is in the above-described ranges, excellent heat resistance and long-term heat resistance are achieved and particles are unlikely to aggregate and have excellent dispersiveness.

The (H) silicone oil has a high heat resistance and bleeds in a resin, and the flowability increases inside a molding machine and the releasability is improved. When the electric wire is extruded from the molding machine, the electric wire is extruded from the tip of a die in a slightly spread state. In this case, if the flowability is low, the electric wire breaks at the mouth of the die, and gum is produced, resulting in the formation of die residue. In contrast, by blending a silicone oil, it is possible to increase the flowability and prevent the formation of die residue.

Examples of the silicone oil include dimethyl silicone oil, methylphenyl silicone oil, and silicone oils modified using fluorine, polyether, alcohol, amino, or phenol. From the viewpoint of excellent compatibility with a polyolefin, alkyl silicone oil such as dimethyl silicone oil is preferable.

Although the silicone oil may be blended in its original state, in order to increase the dispersiveness of silicone, the silicone oil may be immersed in a polyolefin or mixed with a polyolefin to prepare a master batch. A polyolefin that is used in the above-described (A) to (C) or the like can be used as the above-described polyolefin.

By adding a silicone oil to a composition for an electric wire coating material, a silicone layer is formed on the surface of an insulated electric wire and the unevenness of the surface is reduced, as a result of which it is possible to suppress the formation of die residue during molding and to increase the abrasion resistance of the insulated electric wire. Also, the silicone layer plays a char formation role during combustion, and thus the effect as a flame retardant auxiliary agent can also be expected.

The blending amount of the silicone oil is preferably in a range of 0.5 to 5 parts by mass and more preferably in a range of 1.5 to 5 parts by mass, with respect to 100 parts by mass in total of the resin components (A) to (C). If the blending amount thereof is in the above-described range, a small amount of the silicone oil is extracted on the surface of a coating film or the surface of a conductor, and it is possible to obtain the above-described abrasion resistance increase effect, for example and to suppress bleeding of a large amount of silicone oil, and the insulated electric wire has excellent workability for crimping of terminals and the like.

Also, if the silicone oil is mixed with a polyolefin or the like to prepare a master batch, a mixture in which a mass ratio of the silicone oil and the polyolefin is 1:1 is preferably blended in a range of 1 to 10 parts by mass, and more preferably in a range of 3 to 10 parts by mass, with respect to 100 parts by mass in total of the resin components (A) to (C).

The composition for an electric wire coating material according to the present application may contain various additives in a range that does not inhibit an object of the present invention. Examples of the additives include an antioxidant, a metal deactivator, a lubricant, and other general additive agents used in the composition for an electric wire coating material.

A hindered phenol-based antioxidant is preferable as the antioxidant, and in particular, hindered phenol having a melting point of 200° C. or more is preferable. Examples of the hindered phenol-based antioxidant include pentaerythritol tetrakis [3-(3,5-di-tert-butyl-4-hydroxyphenyl)propionate], thiodiethylenebis[3-(3,5-di-tert-butyl-4-hydroxyphenyl)propionate], octadecyl-3-(3,5-di-tert-butyl-4-hydroxyphenyl)propionate, N,N′-hexane-1,6-diylbis[3-(3,5-di-tert-butyl-4-hydroxyphenylpropionamide), benzenepropanoic acid, 3,5-bis(1,1-dimethylethyl)-4-hydroxy, C7-C9 side chain alkyl esters, 2,4-dimethyl-6-(1-methylpentadecyl) phenol, diethyl[[3,5-bis(1,1-dimethylethyl)-4-hydroxyphenyl]methyl]phosphonate, 3,3′,3″,5,5′,5″-hexa-tert -butyl-a,a′,a″-(mesitylene-2,4,6-triyl)tri-p-cresol, calcium diethyl bis[[[3,5-bis(1,1-dimethylethyl)-4-hydroxyphenyl]methyl]phosphonate], 4,6-bis(octylthiomethyl)-o-cresol, ethylenebis(oxyethylene) bis[3-(5-tert-butyl-4-hydroxy-m-tolyl)propionate], hexamethylenebis[3-(3,5-di-tert-butyl-4-hydroxyphenyl) propionate, 1,3,5-tris(3,5-di-tert-butyl-4-hydroxybenzyl)-1,3,5-triazine-2,4,6(1H, 3H, 5H)-trione, 1,3,5-tris[(4-tert-butyl-3-hydroxy-2,6-xylyl)methyl]-1,3,5-triazine-2,4,6 (1H, 3H, 5H)-trione, 2,6-tert-butyl-4-(4,6-bis(octylthiol)-1,3,5-triazin-2-ylamino)phenol, 2,6-di-tert-butyl-4-methylphenol, 2,2′-methylenebis(4-methyl-6-tert-butylphenol), 4,4′-butylidenebis(3-methyl-6-tert-butylphenol), 4,4′-thiobis(3-methyl-6-tert-butylphenol), and 3,9-bis[2-(3-(3-tert-butyl-4-hydroxy-5-methylphenyl)propinox)-1,1-dimethylethyl]-2,4,8,10-tetraoxaspiro(5,5)undecane. These may be used alone or in combination. Examples of the hindered phenol-based antioxidant having a melting point of 200° C. or more include 3,3′,3″,5,5′5″-hexa-tert-butyl-a,a′,a″-(mesitylene-2,4,6-triyl)tri-p-cresol, and 1,3,5-tris(3,5-di-tert-butyl-4-hydroxybenzyl)-1,3,5-triazine-2,4,6(1H,3H,5H)-trione.

The addition amount of the antioxidant is preferably in a range of 1 to 10 parts by mass and more preferably in a range of 1 to 5 parts by mass, with respect to 100 parts by mass in total of the resin components (A) to (C). If the addition amount of the antioxidant is in the above-described range, the composition has an excellent antioxidant effect, and it is possible to suppress blooming and the like that occur when a large amount of the antioxidant is added.

A copper deactivator, a chelating agent, or the like that can prevent oxidation caused by contact with a heavy metal such as copper is used as the metal deactivator. Examples of the metal deactivator include hydrazide derivatives such as 2,3-bis[3-(3,5-di-tert-butyl-4-hydroxyphenyl)propionyl]propionohydrazide and salicylic acid derivatives such as 3-(N-salicyloyl)amino-1,2,4-triazole. Salicylic acid derivatives such as 3-(N-salicyloyl)amino-1,2,4-triazole are preferable as the metal deactivator.

The addition amount of the metal deactivator is preferably in a range of 1 to 10 parts by mass and more preferably in a range of 1 to 5 parts by mass, with respect to 100 parts by mass in total of the resin components (A) to (C). If the addition amount of the metal deactivator is in the above-described range, the composition has an excellent copper damage prevention effect, and it is possible to suppress blooming and crosslinking inhibition that occur when a large amount of the metal deactivator is added.

There is no particular limitation on the lubricant, and either an internal lubricant or external lubricant may be used as the lubricant. Examples of the lubricant include hydrocarbons such as liquid paraffin, paraffin wax, and polyethylene wax, fatty acids such as stearic acid, oleic acid, and erucic acid, higher alcohols, fatty acid amides such as stearic acid amides, oleic acid amides, and erucic acid amides, alkylene fatty acid amides such as methylene bis stearamides and ethylene bis stearamides, and metal soaps such as metal stearates, and ester-based lubricants such as monoglyceride stearate, stearyl stearate, and hardened oil. From the viewpoint of compatibility with resin components, derivatives of fatty acids such as erucic acid, oleic acid, and stearic acid, or polyethylene-based wax is preferably used as the lubricant.

The addition amount of the lubricant is preferably in a range of 1 to 10 parts by mass and more preferably in a range of 1 to 5 parts by mass, with respect to 100 parts by mass in total of the resin components (A) to (C). If the addition amount of the lubricant is in the above-described range, a sufficient lubricant effect is obtained.

Inorganic fillers such as magnesium oxide and calcium carbonate can be used, as an additive agent, for the composition for an electric wire coating material in a small amount. By adding the filler, the hardness of the resin can be adjusted, and workability and high temperature deformation resistance characteristics can be improved. From the viewpoint of the resin strength, the addition amount of the filler is preferably 30 parts by mass or less, and more preferably 5 parts by mass or less with respect to 100 parts by mass in total of the resin components (A) to (C). These inorganic fillers adsorb the functional groups of the (C) copolymerized polyolefin, and the affinity with the resin components can be increased.

Although the composition for an electric wire coating material according to the present invention can be prepared by blending and mixing using a twin-screw extrusion kneader or the like, the components (A) to (H) and various additive components that are added as needed, if a silane-grafted polyolefin and a crosslinking catalyst are mixed, a crosslinking reaction proceeds due to moisture in the air. From the viewpoint of preventing a crosslinking reaction during storage, for example, and other excess reactions, it is preferable to mix various components immediately before an electric wire is coated. As such a method, it is preferable that a silane-grafted batch, a flame retardant batch, a crosslinking catalyst batch are adjusted and formed into pellets respectively.

The silane-grafted batch is contains the (A) silane-grafted polyolefin. The flame retardant batch contains the (B) unmodified polyolefin, (C) copolymerized polyolefin, and (D) flame retardant. The crosslinking catalyst batch contains the (D) crosslinking catalyst and binder resin. The components (E) to (H) and various additive components that are added as needed may be included in any of the silane-grafted batch, flame retardant batch, and crosslinking catalyst batch as long as an object of the present invention is not inhibited.

An insulated electric wire and a wire harness according to the present application will be described.

In the insulated electric wire according to the present application, an outer circumference of a conductor is coated with an insulating layer made of an electric wire coating material (also simply referred to as “coating material”) obtained by crosslinking the above-described composition for an electric wire coating material. There is no particular limitation on the diameter and the material of the conductor of the insulated electric wire, and the diameter and material thereof can be selected as appropriate in accordance with applications of the insulated electric wire. Examples of the conductor include copper, a copper alloy, aluminum, and an aluminum alloy. From the viewpoint of reducing the weight of the electric wire, aluminum or an aluminum alloy is preferable. The insulating layer of the electric wire coating material may be a single layer or multiple layers consisting of two or more layers.

In the insulated electric wire of the present application, the degree of crosslinking of the crosslinked coating material is preferably 50% or more as a gel fraction from the viewpoint of heat resistance. More preferably, the gel fraction of the coating material is 60% or more. In general, the gel fraction of the coating material of the insulated electric wire is used as an index of a crosslinked electric wire in a crosslinked state. The gel fraction of the coating material can be measured in conformity with JASO-D608-92, for example.

In order to manufacture the insulated electric wire of the present application, it is sufficient that the above-described silane-grafted batch, flame retardant batch, and crosslinking catalyst batch are mixed while heated using a general kneader such as a Banbury mixer, a pressure kneader, a kneading extruder, a twin screw extruder, or a roller, and a composition obtained using an extrusion machine or the like is extruded onto the outer circumference of a conductor to coat the conductor, and then is subjected to crosslinking.

As a method for crosslinking the coating material, the coating material can be crosslinked by exposing a coating layer of a coated electric wire to water vapor or water. At this time, crosslinking is preferably performed in a temperature range of room temperature to 90° C. for 48 hours or less. Crosslinking is more preferably performed in a temperature range of 50 to 80° C. for 8 to 24 hours.

The wire harness of the present application includes the above-described insulated electric wire. The wire harness may be a single wire bundle obtained by bundling only the insulated electric wire, or a mixed electric wire bundle obtained by bundling the insulated electric wires and other insulated electric wires in a mixed state. The electric wire bundle is configured as the wire harness by bundling electric wires with a wire harness protecting material such as a corrugate tube, a bundle material such as adhesive tape, or the like.

The insulated electric wire according to the present application can be utilized in various electric wires for automobiles, devices, information communication, power, ships, aircraft, and the like. In particular, the insulated electric wire according to the present application can be suitably utilized as an electric wire for an automobile.

According to ISO 6722, which is an international standard, the electric wires for an automobile are classified into classes A to E in accordance with an allowable heat resistant temperature. The insulated electric wire is made of the electric wire coating material composition, and thus has excellent heat resistance, is optimal for a battery cable to which a high voltage is applied, and can obtain characteristics of class C having a heat resistant temperature of 125° C. or class D having a heat resistant temperature of 150° C.

Although an embodiment of the present application was described in detail above, the present invention is not limited to the above-described embodiment, and various modifications are possible without departing from the gist of the present invention.

### WORKING EXAMPLES

Hereinafter, working examples of the present application will be described in detail, but the present invention is not limited to the working examples.

### (A) Silane-Grafted Polyolefin

Silane-grafted polyolefins (Silane-grafted PE1 to 3, Silane-grafted PP1) were prepared using polyolefin resins shown below as polyolefin, by mixing, with a single screw extrusion kneader having an inner diameter of 25 mm at 140° C., a material obtained by dry-blending 1.5 parts by mass of vinyltrimethoxysilane (manufactured by Shin-Etsu Chemical Co., Ltd., “KBM1003”), and 0.15 parts by mass of dicumyl peroxide (manufactured by NOF CORPORATION, “PERCUMYL-D”) with respect to 100 parts by mass of the polyolefin resin.

A gel fraction of the above-described silane-grafted polyolefin was obtained using a measurement method described below. A material obtained by adding 5 parts by mass of a crosslinking catalyst batch (manufactured by Mitsubishi Chemical Corporation, “Linklon LZ015H”) to 100 parts by mass of the silane-grafted polyolefin was mixed with a “Labo Plastomill” manufactured by TOYO SEIKI CO., LTD. at 200° C. for 5 minutes and the obtained mass-like substance was subjected to compression pressing at 200° C. for 3 minutes to mold a sheet having a thickness of 1 mm. After the obtained molded sheet was crosslinked in a thermohygrostat bath with 60° C. and 95% humidity for 12 hours, the sheet was dried at room temperature for 24 hours.

A test piece having a weight of about 0.1 g was collected from the obtained molded sheet and weighted. Next, the test piece was immersed in a xylene solvent having a temperature of 120° C. and removed therefrom after 20 hours, the removed test piece was dried at 100° C. for 6 hours, and then the dried test piece was weighed. The mass that was expressed in a percentage after the test piece was immersed in the xylene with respect to the mass before immersion in xylene was used as the gel fraction.

Gel fraction%=(the mass after immersion in xylene/the mass before immersion in xylene)×100

The following resins were used as the polyolefins in the silane-grafted polyolefin. The density of the polyolefins before silane-grafting, and the gel fractions after silane-grafting are shown in Table 1.
Silane-grafted PE1: manufactured by Dow Elastomers, “ENR7256.02”
Silane-grafted PE2: manufactured by Dow Elastomers, “ENGAGE 8100”
Silane-grafted PE3: manufactured by Sumitomo Chemical Co., Ltd., “SUMIKATHENE C215”
Silane-grafted PP1: manufactured by Japan Polypropylene Corporation, “NOVATECH EC9”

TABLE 1

| | | Silane- | Silane- | Silane- | Silane- |
|---|---|---|---|---|---|
| | | grafted | grafted | grafted | grafted |
| | | PE1 | PE2 | PE3 | PP1 |
| Density | g/cm³ | 0.885 | 0.870 | 0.920 | 0.920 |
| Gel fraction | mass % | 80 | 85 | 70 | 65 |

### (B) Unmodified Polyolefin

The following resins were used as the unmodified polyolefins (Unmodified PE1 to 4). The density of the polyolefins is shown in Table 2.
Unmodified PE1: manufactured by Dow Elastomers, “ENGAGE 8842”
Unmodified PE2: manufactured by Dow Elastomers, “ENR7256.02”
Unmodified PE3: manufactured by Sumitomo Chemical Co., Ltd., “SUMIKATHENE C215”
Unmodified PE4: manufactured by Japan Polyethylene Corporation, “NOVATECH HDHY331”

TABLE 2

| | | PE1 | PE2 | PE3 | PE4 |
|---|---|---|---|---|---|
| Density | g/cm³ | 0.860 | 0.885 | 0.920 | 0.950 |

### (C) Copolymerized Polyolefin

The following resins were used as the copolymerized polyolefins (Copolymers 1 to 5). Polymerization components of Copolymers 1 to 5 and introduction amounts thereof are shown in Table 3. Note that Polymerization Component 1 is a polymerizable compound having one or two functional groups selected from a carboxy group and an epoxy group, Polymerization Component 2 is a polymerizable monomer having a functional group other than the carboxy group and the epoxy group, and the base monomer is an olefin monomer having no functional groups.

Also, Copolymer 5 that was used as an alternate product is a resin that does not contain a carboxy group or an epoxy group and is obtained by copolymerizing methyl acrylate and ethylene. Graft-modified PE1 and 2 are resins obtained by introducing maleic acid and an epoxy group through graft polymerization.
Copolymer 1: manufactured by ARKEMA, “LOTADER LX4110”
Copolymer 2: manufactured by ARKEMA, “LOTADER 3430”
Copolymer 3: manufactured by ARKEMA, “LOTADER A4503”
Copolymer 4: manufactured by ARKEMA, “LOTADER A8930”

### Alternate Products for Component (C)

Copolymer 5: manufactured by ARKEMA, “LOTRYL 24MA02T”
Graft-modified PE1 (maleic acid modified): manufactured by Mitsubishi Chemical Corporation, “ADMER QB600”
Graft-modified PE2 (epoxy modified): manufactured by Sumitomo Chemical Co., Ltd., “BONDFAST E (E-GMA)”

TABLE 3

| | | | Copolymer 1 | Copolymer 2 | Copolymer 3 | Copolymer 4 | Copolymer 5 |
|---|---|---|---|---|---|---|---|
| Polymerization | monomer | — | MAH | MAH | MAH | GMA | |
| on | introduction | mass | 3 | 3 | 0.3 | 3 | |
| Component 1 | amount | % | | | | | |
| Polymerization | monomer | — | EA | MA | MA | MA | MA |
| on | introduction | mass | 5 | 15 | 20 | 25 | 25 |
| Component 2 | amount | % | | | | | |

| | | | | | | |
|---|---|---|---|---|---|---|
| Base monomer | — | ethylene | ethylene | ethylene | Ethylene | ethylene |

MAH: maleic anhydride
GMA: glycidyl methacrylate
EA: ethyl acrylate
MA: methyl acrylate

Components other than the above are as follows.

### (D) Inorganic Flame Retardant or Inorganic Flame Retardant Auxiliary Agent

Magnesium Hydroxide 1: manufactured by Kyowa Chemical Industry Co., Ltd., “KISUMA 5”
Magnesium Hydroxide 2: manufactured by Albemarle Corporation, “Magnifin H10”

### (E) Crosslinking Catalyst

Crosslinking catalyst batch: manufactured by Mitsubishi Chemical Corporation, “Linklon LZ015H”

### (F) Age Resister

Zinc oxide: manufactured by Hakusui Tech Co., Ltd.
Imidazole compound: manufactured by Kawaguchi Chemical Industry Co., Ltd., “ANTAGE MB” (2-mercaptobenzimidazole)
Zinc sulfide: manufactured by Sachtleben Chemie Gmbh, “SACHTOLITH”

### (G) Antioxidant, Metal Deactivator, and Lubricant

Antioxidant 1: manufactured by Basf Japan Ltd., “IRGANOX 1010”
Antioxidant 2: manufactured by Basf Japan Ltd., “IRGANOX 3114”
Metal deactivator: manufactured by ADEKA CORPORATION, “CDA-1”

### (H) Silicone Oil

Silicone oil: manufactured by Dow Corning Toray Co., Ltd., “SILICONE CONCENTRATE BY27-002”

### Other Inorganic Fillers

Calcium carbonate: manufactured by MARUO CALCIUM CO., LTD., “SUPER#1700”

### Preparation of Silane-Grafted Batch

Silane-grafted polyolefins were formed into pellets and used as silane-grafted batches.

### Preparation of Crosslinking Catalyst Batch

“Linklon LZ015H” that was supplied as pellets in advance and manufactured by Mitsubishi Chemical Corporation was used as the crosslinking catalyst batch. “Linklon LZ015H” contains a binder resin and a tin compound as a crosslinking catalyst.

### Preparation of Flame Retardant Batch

Among the components shown in Tables 4 and 5, other components other than the silane-grafted polyolefins and crosslinking catalyst batches were added to a twin-screw extrusion kneader, heated and mixed at 200° C. for about 0.1 to 2 minutes, sufficiently dispersed, and then formed into pellets to prepare the flame retardant batches.

### Production of Insulated Electric Wire

Extrusion processing was performed by mixing, with a hopper of the extruder, the silane-grafted batch, the flame retardant batch, and the crosslinking catalyst batch in blending amount ratios shown in Table 4 and Table 5, and setting the temperature of the extruder at 200° C. In the extrusion processing, a coating material was formed by coating a conductor having an outer diameter of 2.4 mm with an insulator having a thickness of 0.7 mm as the extrusion coating (the outer diameter of the coating was 3.8 mm). Thereafter, an insulated electric wire was produced by performing crosslinking treatment for 24 hours in a thermohygrostat bath having a temperature of 65° C. and a humidity of 95%.

The moisture mount, molding productivity, ISO flame retardancy, gel fraction, ISO abrasion resistance, ISO heat deformability, and flexibility of the obtained compositions for an electric wire coating material and insulated electric wires were tested and evaluated. Evaluation results are shown in Table 4 and Table 5. Note that testing methods and evaluation standards are as follows.

### Moisture Amount

The moisture amount of the pellets in the produced flame retardant batches was measured using a Karl Fischer moisture meter (manufactured by KYOTO ELECTRONICS MANUFACTURING CO., LTD., “MCU-610”) at 190° C. for 20 minutes. Pellets having a moisture amount of 700 ppm or less were regarded as acceptable “G (good)”, pellets having a moisture amount of 500 ppm or less were regarded as superior “E (excellent)”, and pellets having a moisture amount of more than 700 ppm were regarded as not acceptable “P (poor)”.

### Molding Productivity

A linear velocity was increased or decreased at the time of extrusion of an electric wire, and it was evaluated whether or not hardened material that had diameter within a range of ±0.2 mm with respect to a designed outer diameter of 3.8 mm and a diameter of 0.1 mm or more on an outer surface or a round cross section of a coating was produced. A case where the designed outer diameter was obtained even at a linear velocity of 50 m/min or more and no hardened material was produced was regarded as acceptable “G”, and a case where the designed outer diameter was obtained even at a linear velocity of 100 m/min or more and no hardened material was produced was regarded as superior “E”, and a case where the designed outer diameter was not obtained at a linear velocity of 50 m/min or more or hardened material was produced was regarded as not acceptable “P”.

### ISO Flame Retardancy

In conformity with ISO 6722, a case where fire was extinguished within 70 seconds was regarded as acceptable “G”, and a case where fire was not extinguished within 70 seconds was regarded as not acceptable “P”.

### Gel Fraction

Gel fractions were measured in conformity with JASO D 608-92. That is, samples having a weight of about 0.1 g were collected from the coating material of the crosslinked insulated electric wires and weighed. Those samples were introduced into test tubes, 20 mL of xylene was added, and the mixture was heated in a thermostat oil bath having a temperature of 120° C. for 24 hours. Thereafter, the samples were removed, dried in a drier having a temperature of 100° C. for 6 hours, cooled down to room temperature, and then weighted. The mass that was expressed in a percentage after testing with respect to the mass before testing was used as the gel fraction. A sample having a gel fraction of 50% or more was regarded as acceptable “G”, a sample having a gel fraction of 60% or more was regarded as superior “E”, and a sample having a gel fraction of less than 50% was regarded as not acceptable “P”.

### ISO Abrasion Resistance

In conformity with ISO 6722, an iron wire having an outer diameter of 0.45 mm was pressed at a load of 7N against the crosslinked insulated electric wire, was moved back and forth at a speed of 55 movements/min, and the number of instances until the iron wire and copper that was the conductor electrically communicated with each other was measured. A case where the number of instances was 700 or more was regarded as acceptable “G”, a case where the number of instances was 1000 or more was regarded as superior “E”, and a case where the number of instances was less than 700 was regarded as not acceptable “P”.

### ISO Heat Deformability

In conformity with ISO 6722, a 0.7-mm blade was pressed at a load of 190 g against the crosslinked insulated electric wire, the insulated wire was left in a thermostat bath having a temperature of 150° C. for 4 hours, and then was subjected to a voltage tolerance test in a 1% saline solution at 1 kv for 1 minute. A case where insulation break did not occur was regarded as acceptable “G”, and a case where insulation break occurred was regarded as not acceptable “P”. Also, in the case of being regarded as acceptable, a ratio of a thickness after the removal from the thermostat bath with respect to a cumulative thickness in the same direction of the insulating coatings (for example, in the case where one side was 0.7 mm, 0.7×2=1.4 mm) before the electric wire was introduced in the above-described thermostat bath was used as a remaining percentage, and a case where the remaining percentage was 75% or more was regarded as superior “E”.

### Flexibility

Three point bending flexibility test was performed using “Autograph AG-01” manufactured by Shimadzu Corporation, in conformity with JIS K7171. That is, the crosslinked insulated electric wire was cut to have a length of 100 mm, three cut insulated wires were arranged side by side, a test piece was produced by fixing two ends using polyvinyl chloride tape, the test piece was bent with a gap between columns of 50 mm and a test speed of 1 mm/min, and the maximum load was measured. A case where the load was 3 N or less was regarded as acceptable “G”, and a case where the load was greater than 3 N was regarded as not acceptable “P”.

TABLE 4

| | Work. | Work. | Work. | Work. | Work. | Work. | Work. | Work. |
|---|---|---|---|---|---|---|---|---|
| Working Examples | Ex. 1 | Ex. 2 | Ex. 3 | Ex. 4 | Ex. 5 | Ex. 6 | Ex. 7 | Ex. 8 |
| Silane-grafted PE1 | 60 | | | | | 80 | | |
| Silane-grafted PE2 | | 70 | | | | | 90 | |
| Silane-grafted PE3 | | | 50 | 60 | | | | 60 |
| Silane-grafted PP1 | | | | | 50 | | | |
| Unmodified PE1 | 35 | | | | | | | |
| Unmodified PE2 | | | 40 | | 25 | 10 | 5 | |
| Unmodified PE3 | | | | 25 | | | | |
| Unmodified PE4 | | 20 | | | | | | |
| Copolymer 1 | 5 | | | | | 10 | | 5 |
| Copolymer 2 | | 10 | | | | | | 5 |
| Copolymer 3 | | | 10 | | 15 | | | |
| Copolymer 4 | | | | 15 | | | 5 | |
| Copolymer 5 | | | | | | | | |
| Graft-modified | | | | | | | | |
| Polyolefin 1 | | | | | | | | |
| Graft-modified | | | | | | | | |
| Polyolefin 2 | | | | | | | | |
| Magnesium | | | | | 100 | 100 | | |
| Hydroxide 1 | | | | | | | | |
| Magnesium | 80 | 70 | 90 | 100 | | | 60 | 150 |
| Hydroxide 2 | | | | | | | | |
| Zinc oxide | | 10 | | | 5 | 10 | 7 | 5 |
| Imidazole | | 10 | | | 5 | 10 | 7 | 5 |
| compound | | | | | | | | |
| Zinc sulfide | 10 | | 10 | 10 | | | | |
| Antioxidant 1 | 1 | 1 | 1 | 1 | | | | |
| Antioxidant 2 | | | | | 1 | 1 | 1 | 1 |
| Metal | 0.5 | 0.5 | 0.5 | 0.5 | 0.5 | 0.5 | 0.5 | 0.5 |
| deactivator | | | | | | | | |
| Silicone oil | | | | | | | 3 | |
| Calcium | | | | | 10 | | | 10 |
| carbonate | | | | | | | | |
| Crosslinking | 5 | 5 | 5 | 5 | 5 | 5 | 5 | 5 |
| catalyst batch | | | | | | | | |
| Total | 196.5 | 196.5 | 206.5 | 216.5 | 216.5 | 226.5 | 183.5 | 281.5 |
| Moisture amount | E | E | G | G | G | E | G | E |
| Molding | E | E | G | G | G | E | G | E |
| productivity | | | | | | | | |
| ISO flame | G | G | G | G | G | G | G | G |
| retardancy | | | | | | | | |
| Gel fraction | G | E | G | G | G | E | E | G |
| ISO abrasion | E | E | E | E | G | E | G | E |
| resistance test | | | | | | | | |
| ISO heat | E | E | G | G | G | E | G | G |
| deformability test | | | | | | | | |
| Flexibility | E | E | G | G | G | G | E | G |

TABLE 5

| | Work. | Work. | Comp. | Comp. | Comp. | Comp. | Comp. | Comp. |
|---|---|---|---|---|---|---|---|---|
| Working Examples | Ex. 9 | Ex. 10 | Ex. 1 | Ex. 2 | Ex. 3 | Ex. 4 | Ex. 5 | Ex. 6 |
| Silane-grafted PE1 | | | 60 | 60 | | | | 80 |
| Silane-grafted PE2 | | 82 | | | 60 | | | |
| Silane-grafted PE3 | | | | | | | 60 | |
| Silane-grafted PP1 | 50 | | | | | | | |
| Unmodified PE1 | | 10 | 35 | | | | | |
| Unmodified PE2 | 25 | | | | | 90 | | 10 |
| Unmodified PE3 | | | | 30 | | | 25 | |
| Unmodified PE4 | | | | | | | | |
| Copolymer 1 | | 8 | | | | | | 10 |
| Copolymer 2 | | | | | | | | |
| Copolymer 3 | 15 | | | | | 10 | | |
| Copolymer 4 | | | | | | | | |
| Copolymer 5 | | | | | | | 15 | |
| Graft-modified | | | 5 | 10 | | | | |
| Polyolefin 1 | | | | | | | | |
| Graft-modified | | | | | 40 | | | |
| Polyolefin 2 | | | | | | | | |
| Magnesium | 100 | | 80 | 150 | | | | 100 |
| Hydroxide 1 | | | | | | | | |
| Magnesium | | 55 | | | | 90 | 100 | |
| Hydroxide 2 | | | | | | | | |
| Zinc oxide | | 0.8 | 10 | 2 | 10 | | | 10 |
| Imidazole compound | | 0.8 | | 2 | 10 | | | 10 |
| Zinc sulfide | | | | 10 | | 10 | 10 | |
| Antioxidant 1 | | | 1 | 1 | 1 | 1 | 1 | |
| Antioxidant 2 | 1 | 3 | | | | | | 1 |
| Metal deactivator | 0.5 | 0.5 | 0.5 | 0.5 | 0.5 | 0.5 | 0.5 | 0.5 |
| Silicone oil | | | | | | | | |
| Calcium carbonate | 10 | | | | | | | |
| Crosslinking catalyst | 5 | 5 | 5 | 5 | 5 | 5 | 5 | |
| batch | | | | | | | | |
| Total | 206.5 | 165.1 | 196.5 | 270.5 | 126.5 | 206.5 | 216.5 | 221.5 |
| Moisture amount | G | G | P | P | G | G | P | E |
| Molding productivity | G | G | P | P | P | G | P | E |
| ISO flame retardancy | G | G | G | G | P | G | G | G |
| Gel fraction | G | G | G | G | P | P | G | P |
| ISO abrasion | G | G | G | G | P | G | G | E |
| resistance test | | | | | | | | |
| ISO heat | G | G | G | G | G | P | G | P |
| deformability test | | | | | | | | |
| Flexibility | G | G | G | G | G | G | G | G |

According to Tables 4 and 5, Comparative Examples 1 and 2 did not contain the (C) copolymerized polyolefin, and thus had poor affinity with inorganic components and resin components, as a result of which the moisture amount increased and Comparative Examples 1 and 2 had poor molding productivity. Note that in these comparative examples, Graft-modified Polyolefin 1 that was used instead of a copolymerized polyolefin was a polyolefin obtained by graft polymerizing maleic acid, and the modification ratio was 0.5 mass % or less, and thus Graft-modified Polyolefin 1 had little effect in improving the affinity with the inorganic components and the resin components. Comparative Example 3 did not contain an inorganic flame retardant, and thus had poor flame retardancy and its abrasion resistance decreased. Also, Comparative Example 3 contained a large amount of graft-modified polyolefin instead of an unmodified polyolefin and a copolymerized polyolefin, and thus resin burning was produced during mixing, and the gel fraction and the molding productivity decreased. Comparative Example 4 did not contain a silane-grafted polyolefin, and thus the resin was not crosslinked, and Comparative Example 4 had a low gel fraction and poor heat deformability resistance. Copolymerized Polyolefin 5 that was used in Comparative Example 5 was a copolymer of methyl acrylate and ethylene, and did not contain a carboxy group or an epoxy group, and thus Comparative Example 5 had little effect in improving the affinity with inorganic components and resin components, as a result of which the moisture amount increased and Comparative Example 5 had poor molding productivity. Comparative Example 6 did not contain the crosslinking catalyst batch, and thus a crosslinking reaction of the resin was unlikely to proceed, and Comparative Example 6 had a low gel fraction and poor heat deformability resistance.

On the other hand, the working examples that satisfy the configuration of the present invention had excellent flame retardancy, abrasion resistance, flexibility, and molding productivity, and the pellets have a low moisture adsorption amount. Also, Working Example 5 in which the component (F) was added had a better long-term heat resistance compared to Working Example 10 in which the component (F) was not added.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A composition for an electric wire coating material comprising:
(A) a silane-grafted polyolefin obtained by grafting a silane coupling agent onto a polyolefin having a density of 0.860 to 0.920 g/cm³;
(B) an unmodified polyolefin having a density of 0.860 to 0.955 g/cm³;
(C) a copolymerized polyolefin of a polymerizable compound having one or two functional groups selected from a carboxy group and an epoxy group, and at least one polymerizable monomer that can be copolymerized with the polymerizable compound having the functional groups;
(D) an inorganic flame retardant or an inorganic flame retardant auxiliary agent; and
(E) a crosslinking catalyst.

2. The composition for an electric wire coating material according to claim 1, further comprising:
(F) a combination of zinc oxide and an imidazole-based compound, or zinc sulfide.

3. The composition for an electric wire coating material according to claim 1, further comprising:
(G) one or more selected from an antioxidant, a metal deactivator, and a lubricant.

4. The composition for an electric wire coating material according to claim 1, further comprising:
(H) a silicone oil.

5. The composition for an electric wire coating material according to claim 1,
wherein a polymerizable monomer of the (C) copolymerized polyolefin has one or more functional groups selected from an acrylic group, a methacrylic group, an ester group, a hydroxy group, and an amino group.

6. The composition for an electric wire coating material according to claim 1,
wherein the (C) copolymerized polyolefin is a multi-component copolymerized polyolefin constituted by
a polymerizable compound having one or two functional groups selected from a carboxy group and an epoxy group,
a polymerizable monomer having one or more functional groups selected from an acrylic group, a methacrylic group, an ester group, a hydroxy group, and an amino group, and
an olefin monomer having no functional groups.

7. The composition for an electric wire coating material according to claim 1,
wherein the (C) copolymerized polyolefin contains a polymerizable compound having a carboxy group, and
the polymerizable compound having a carboxy group is one or more selected from maleic acid, maleic anhydride, and derivatives thereof.

8. The composition for an electric wire coating material according to claim 1, comprising:
the (A) silane-grafted polyolefin in an amount of 30 to 90 parts by mass;
the (B) unmodified polyolefin and the (C) copolymerized polyolefin in an amount of 10 to 70 parts by mass in total; and
with respect to 100 parts by mass in total of the (A), (B), and (C) components,
the (D) inorganic flame retardant in an amount of 50 to 200 part by mass;
a crosslinking catalyst batch in an amount of 2 to 20 parts by mass, the crosslinking catalyst batch containing the (E) crosslinking catalyst in an amount of 0.5 to 5 parts by mass with respect to 100 parts by mass of a binder resin;
zinc oxide and the imidazole-based compound each in an amount of 1 to 15 parts by mass if the (F) component is the combination of zinc oxide and the imidazole-based compound, or zinc sulfide in an amount of 1 to 15 parts by mass if the (F) component is zinc sulfide;
the (G) antioxidant, metal deactivator, and lubricant each in an amount of 1 to 10 parts by mass; and
the (H) silicone oil in an amount of 0.5 to 5 parts by mass.

9. The composition for an electric wire coating material according to claim 1,
wherein polyolefins that constitute the (A) silane-grafted polyolefin and the (B) unmodified polyolefin are each one or more selected from very-low-density polyethylene, linear low-density polyethylene, and low-density polyethylene.

10. The composition for an electric wire coating material according to claim 1,
wherein the (C) copolymerized polyolefin contains one or two selected from a carboxy group and an epoxy group in an amount of 0.5 to 5 mass % in total.

11. An insulated electric wire comprising:
an electric wire coating material obtained by crosslinking the composition for an electric wire coating material according to claim 1.

12. A wire harness comprising:
the insulated electric wire according to claim 11.
